(19) United States
(12) Patent Application Publication
(10) Pub. No.: US 2011/0156852 A1
(43) Pub. Date: Jun. 30, 2011

(54) ELECTRONIC APPARATUS AND COMMUNICATION DEVICE

(75) Inventor: Keisuke UNNO, Kanagawa (JP)

(73) Assignee: SONY CORPORATION, Tokyo (JP)

(21) Appl. No.: 12/914,280

(22) Filed: Oct. 28, 2010

(30) Foreign Application Priority Data
Dec. 28, 2009 (JP) 2009-297767

(51) Int. Cl. H01F 27/02

(52) U.S. Cl. 336/90

(57) ABSTRACT

An electronic apparatus includes: an electric field reinforcing member as a plate-like metal provided in a predetermined position within an outer casing set in response to a specified position of a coupler for generating electric field coupling between a communication destination coupler located within a predetermined communicable distance and itself within the outer casing, having an outer shape in which two leg parts having a positional relationship spaced from each other and a joining part joining the respective one ends of the leg parts are integrally formed, and having lengths of side parts forming an interior of the outer shape set based on a half of a wavelength in response to an electric field frequency generated by the electric field coupling.

### BACKGROUND OF THE INVENTION

1. Field of the Invention

The present invention relates to an electronic apparatus and a communication device, and specifically, to an electronic apparatus and a communication device used for near-field wireless communications by electric field coupling.

2. Description of the Related Art

For example, near-field wireless communications standards called TransferJet (registered trademark) is being put into practical use (for example, see TransferJet Whitepaper, TransferJet Consortium (http//www.transferjet.org/tj/transferjet_whitepaper_J.pdf)). In the near-field wireless communications standards, a very short communicable distance of about 3 to 5 cm is specified.

Further, in TransferJet, an induction phenomenon by electric field coupling is utilized for realization of the communications limited within a near-field range, and an electric field coupler called “coupler” corresponding to an antenna is used. That is, a coupler that one communication apparatus has and a coupler that the other communication apparatus has come close to each other within a communicable distance, and thereby, electric field coupling is generated between the couplers. By the electric field coupling, they are connected to be able to transmit signals between the apparatuses.

### SUMMARY OF THE INVENTION

However, in actual communications between an electronic apparatus with couplers accommodated within the electronic apparatus, the following problems have arisen. For example, in some cases, the outer casing of the electronic apparatus having a coupler inside is made of metal, or a metal part is provided near the location where the coupler is to be provided within the outer casing. That is, they are the cases where a metal exists in or near the electric field generated between couplers. The metal is a conductor, and accordingly, weakens the electric field due to its reflection and shielding effects. That power reduction of the electric field may lead to deterioration of communication quality of the higher error rate, the lower communication speed, or the like, and, in practice, may become a factor for hindering stable transmission and reception of data.

To avoid the deterioration in communication quality, for example, measures that no metal is used for the outer casing, no metal part is provided near the coupler within the outer casing, or the like may be taken. However, taking these measures is not practical because problems of deterioration in apparatus design and difficulty in securement of strength arise, for example.

Accordingly, it is desirable that sufficient communication quality can be maintained even when a metal is provided near a coupler.

According to an embodiment of the invention, there is provided an electronic apparatus including an electric field reinforcing member as a plate-like metal provided in a predetermined position within an outer casing set in response to a specified position of a coupler for generating electric field coupling between a communication destination coupler located within a predetermined communicable distance and itself within the outer casing, having an outer shape in which two leg parts having a positional relationship spaced from each other and a joining part joining the respective one ends of the leg parts are integrally formed, and having lengths of side parts forming an interior of the outer shape set based on a half of a wavelength in response to an electric field frequency generated by the electric field coupling. Thereby, there is an advantage that the electric field reinforcing member receives the electric field from the coupler and reradiates it to the communication destination coupler side.

Further, in this embodiment, the electric field reinforcing member may be provided in contact with or close to a dielectric material within the outer casing, and the lengths of the side parts forming the interior of the outer casing may be set based on the half of the wavelength shortened according to permittivity of the dielectric material. Thereby, there is an advantage that the lengths of the side parts forming the interior of the outer shape of the electric field reinforcing member are shortened.

Furthermore, in this embodiment, the electric field reinforcing member may have the outer shape in a direction of the plate-like flat surface, and a surface part formed by one leg part and a surface part formed by the other leg part may form a predetermined angle using a direction along the two leg parts in apart corresponding to the joining part as a bending position. Thereby, there is an advantage that a direction of radiation of the electric field is set in the electric field reinforcing member, for example.

Moreover, in this embodiment, the surface part formed by one leg part in the electric field reinforcing member may be located near the specified position of the coupler within the outer casing and the surface part formed by the other leg part in the electric field reinforcing member may be located nearer the communication destination coupler than the specified position of the coupler within the outer casing. Thereby, there is an advantage that the operation of receiving the electric field and the operation of radiating the electric field are allowed to effectively function in the electric field reinforcing member.

In addition, in this embodiment, the electric field reinforcing member may be formed in a looped shape along the outer shape. Thereby, there is an advantage that a loop of about one wavelength is formed.

Further, in this embodiment, the electric field reinforcing member may be formed so that a thickness part of the plate-like metal may have the outer shape. Thereby, there is an advantage that the electric field reinforcing member of the bended plate-like metal is formed.

Furthermore, in this embodiment, the electric field reinforcing member may be provided in a position between the specified position of the coupler within the outer casing and the communication destination coupler. Thereby, there is an advantage that the electric field reinforcing member is located between the couplers of the communication partners, i.e., in the electric field.

Moreover, in this embodiment, the electric field reinforcing member may have the two leg parts having different lengths from each other. Thereby, there is an advantage that the electric field reinforcing member in the shape including the two leg parts having different lengths is provided.

In addition, in this embodiment, a communication device attaching and detaching part as a part in and from which a communication device including the coupler is attached and detached formed so that, if the communication device is properly loaded, the coupler may be located in the specified position within the outer casing. Thereby, an effect that the electric field reinforcing member is allowed to effectively function for communication devices loaded in the communication device attaching and detaching parts in common.

Further, according to another embodiment of the invention, there is provided a communication device for generating electric field coupling between a communication destination coupler located within a predetermined communicable distance and itself, including a coupler provided in a predetermined position within an outer casing, and an electric field reinforcing member as a plate-like metal having an outer shape in which two leg parts having a positional relationship spaced from each other and a joining part joining the respective one ends of the leg parts are integrally formed, and having lengths of side parts forming an interior of the outer shape set based on a half of a wavelength in response to an electric field frequency generated by the electric field coupling. Thereby, there is an advantage that the communication device is allowed to have a function of reinforcing the electric field generated by electric field coupling.

According to the embodiments of the invention, as the electronic apparatus compliant with near-field wireless communications system using electric field coupling, even when the electronic apparatus has the above described structure in which a metal is provided near the coupler, an effect that sufficient communication quality may be maintained by a simple configuration.

### BRIEF DESCRIPTION OF THE DRAWINGS

FIG. 1 is a block diagram showing a configuration example of a transmitting device and a receiving device in a first embodiment of the invention.

FIG. 2 is a diagram for explanation of electric field coupling between a coupler of the transmitting device and a coupler of the receiving device in the first embodiment of the invention.

FIGS. 3A to 3C show an example of arrangement of the coupler in an outer casing of the transmitting device.

FIGS. 4A and 4B are a front view and a side view showing an example of an electric field reinforcing member in the first embodiment of the invention.

FIG. 5 extracts and shows the electric field reinforcing member in the first embodiment of the invention in a front view.

FIGS. 6A and 6B show another example of a positional relationship of the electric field reinforcing member and the coupler in the first embodiment of the invention.

FIGS. 7A and 7B show another example of the positional relationship of the electric field reinforcing member and the coupler in the first embodiment of the invention.

FIG. 8 shows a specific arrangement example of the electric field reinforcing member within the outer casing in the first embodiment of the invention.

FIG. 9 shows the case where a card-type communication device is detachable as a specific arrangement example of the electric field reinforcing member within the outer casing in the first embodiment of the invention.

FIG. 10 is a perspective view schematically showing an arrangement form within the outer casing when the electric field reinforcing member is provided in the transmitting device and receiving device, respectively.

FIGS. 11A and 11B are a front view and a side view showing a configuration example of an electric field reinforcing member in a first modified example of the embodiment of the invention.

FIG. 12 extracts and shows the electric field reinforcing member in the first modified example.

FIGS. 13A and 13B are a front view and a side view showing an example of a bent shape of the electric field reinforcing member and its arrangement example in the first modified example of the embodiment of the invention.

FIGS. 14A to 14C are a perspective view and side views showing a configuration example of an electric field reinforcing member in a second modified example of the embodiment of the invention.

FIGS. 15A and 15B show configuration examples of electric field reinforcing members in a third modified example of the embodiment of the invention.

### DESCRIPTION OF PREFERRED EMBODIMENTS

As below, embodiments for implementing the invention (hereinafter, referred to as embodiments) will be explained.

The explanation will be made in the following order.

1. First Embodiment (an example of forming a slit in an electric field reinforcing member)

2. Modified Examples (modified examples of forms of an electric field reinforcing part)

### 1. First Embodiment

### Outline of Near-Field Wireless Communications System

First, an outline of near-field wireless communications standards with which the embodiments of the invention are compliant will be explained. The near-field wireless communications standards with which the embodiments of the invention are compliant are so-called TransferJet (registered trademark). As its communicable distance, a very short distance of about 3 cm to 5 cm is set, and it is assumed that a considerably high data transfer speed of 560 Mbps at the maximum (effective speed: 375 Mbps) may be obtained within the range of the communicable distance. Further, its network topology (communication mode) is constantly one to one (Point-to-Point).

In the TransferJet standards, Point-to-Point communications at a communication distance limited to several centimeters is employed as described above, and, for example, the security level comparable to that of wired connection may be obtained without encryption. Further, the communication frequency occupies a bandwidth of 560 MHz around 4.48 GHz, and in the communications protocol, error detection, correction and recognition, retransmission of packets are specified. Furthermore, because of near-field communications, the communication power is very low, −70 dBm/MHz or less. Thereby, for example, authorization is unnecessary in this country and other main countries.

As a communication apparatus that is compliant with the TransferJet standards, for example, a convenient usage mode such that, only by placing an imaging device on a storage apparatus, image data stored in the imaging device is transferred to the storage apparatus may be proposed.

Here, the communicable distance of about 3 cm specified by TransferJet is realized not using normal radio waves, but using an induction phenomenon by electric field coupling. An electric field coupler that functions as an antenna for wireless connection by the electric field coupling is called “coupler” in the TransferJet standards. In this specification, hereinafter, the electric field coupler is referred to as “coupler”.

### [Configuration of Communication Device]

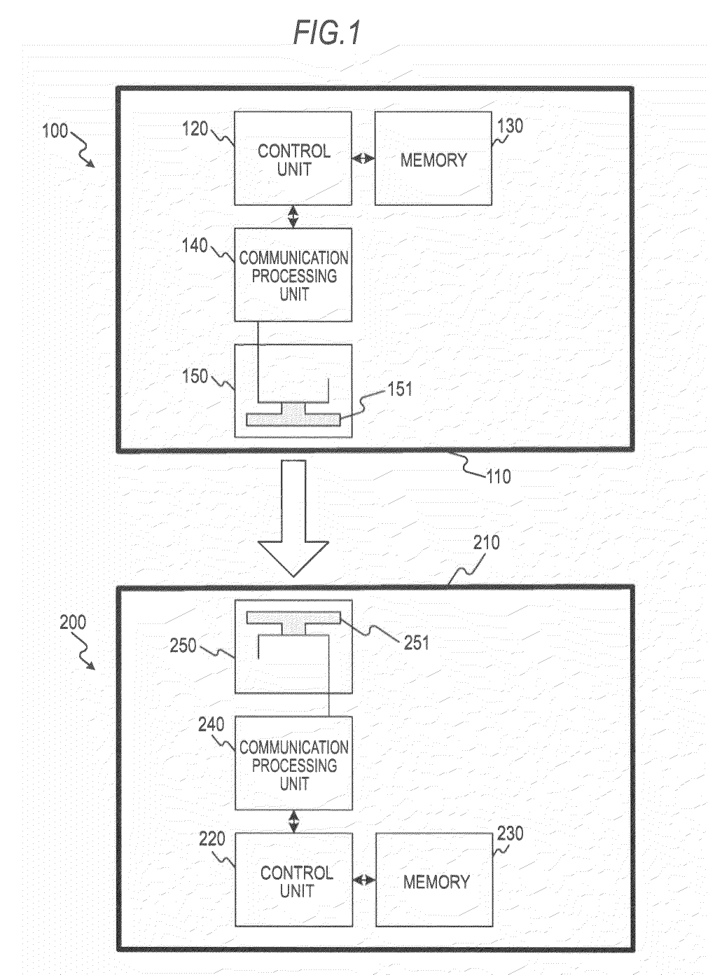

FIG. 1 shows a transmitting device 100 and a receiving device 200 as communication devices with which the embodiments of the invention are compliant. The transmitting device 100 and the receiving device 200 may be devices of the same type in practice, and they may function as the data transmission side and the data reception side, respectively, in response to setting and operation at the time. Or, the transmitting device 100 and the receiving device 200 may be different devices from each other.

In FIG. 1, the transmitting device 100 executes a data transmitting function as a communication device. The transmitting device 100 includes a control unit 120, a memory 130, a communication processing unit 140, and a coupler 150 within its outer casing 110.

The outer casing 110 is a part for the exterior formed by a resin or metal, and accommodates real circuits, parts, etc. forming the transmitting device 100 within.

The control unit 120 is a CPU (Central Processing Unit) in practice, for example, and executes various kinds of control in the transmitting device 100. Specifically, writing/reading of data for the memory 130 and the operation of the communication processing unit 140 compliant with near-field wireless communications are controlled. The memory 130 holds data to be used by the control unit 120. Specifically, for example, the memory holds data to be transmitted by near-field wireless communications. The communication processing unit 140 executes necessary processing for data transmission by near-field wireless communications in response to the control of the control unit 120.

Further, the coupler 150 generates electric field coupling between a coupler provided at the apparatus side as the destination of communication and itself. For example, at data transmission, the coupler generates an electric field in response to a transmission signal output from the communication processing unit 140. In the coupler 150, for example, the transmission signal from the communication processing unit 140 is applied to a radiator 151. Thereby, electric fields that change in response to the transmission signals may be generated from the radiator 151.

In the same FIG. 1, the receiving device 200 executes a data receiving function as a communication device, and includes a control unit 220, a memory 230, a communication processing unit 240, and a coupler 250 within its outer casing 210.

The configurations of the outer casing 210, the control unit 220, the memory 230, the communication processing unit 240, and the coupler 250 at the receiving device 200 side may be the same as those of the outer casing 110, the control unit 120, the memory 130, the communication processing unit 140, and the coupler 150 at the transmitting device 100 side, respectively. Note that, in response to that the receiving device 200 executes the data receiving function, the control unit 220 executes control corresponding to data reception. Further, in the memory 230, the received data is held. Furthermore, the communication processing unit 240 executes processing of demodulating and acquiring data from the signals received via the coupler 250. The coupler 250, as an operation, passes the signal detected in the radiator 251 in response to the induced electric field to the communication processing unit 240 as a reception signal.

### [Examples of Communication Processing Between Communication Devices and Communication Operation by Electric Field Coupling]

Operation examples for data transmission and reception performed between the transmitting device 100 and the receiving device 200 having the above described configurations will be explained. For example, when a user allows the data transmission and reception to be performed between the transmitting device 100 and the receiving device 200, the coupler 150 at the transmitting device 100 side and the coupler 250 at the receiving device 200 side may be provided in the positional relationship within the range of the communicable distance. When the transmitting device 100 executes data transmission under the condition, for example, the control unit 120 reads out the data to be transmitted from the memory 130 and passes the data to the communication processing unit 140. The communication processing unit 140 performs processing of addition of error-correction codes, packetization, etc. on the passed data, further performs modulation processing of conversion into transmission signals modulated at a transferable carrier frequency according to the electric field coupling scheme, and outputs the transmission signals to the coupler 150. In the coupler 150, the input transmission signals are applied to the radiator 151, and thereby, from the radiator 151, an electric field in response to the applied transmission signals is generated.

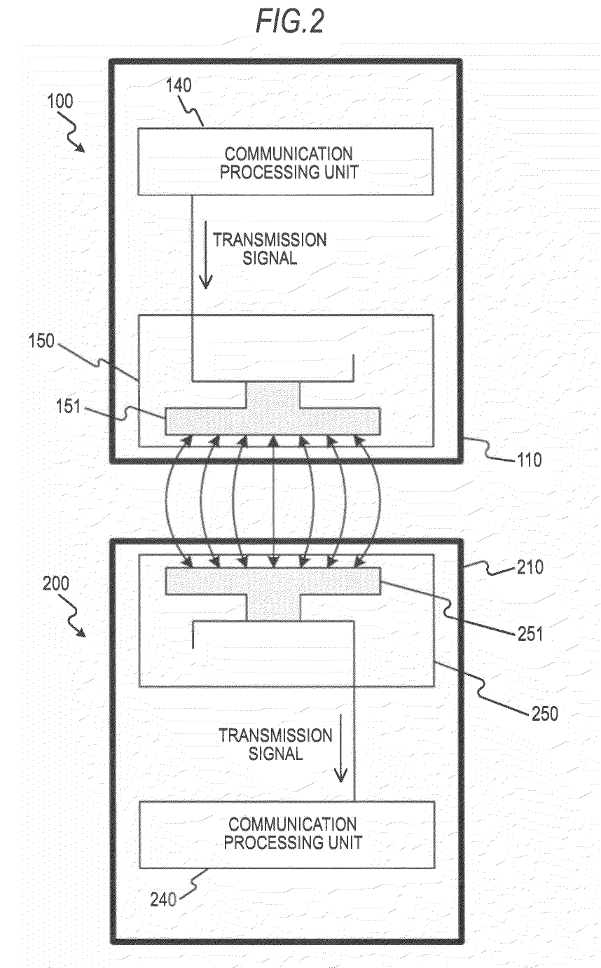

Concurrently, since the coupler 250 at the receiving device 200 side is within the range of the communicable distance with the coupler 150, in the radiator 251 of the coupler 250, an electric field is generated because of the induction phenomenon in response to the electric field generated in the radiator 151. That is, as shown in FIG. 2, an electric field coupling condition is obtained between the radiator 151 of the coupler 150 at the transmitting device 100 side and the radiator 251 of the coupler 250 at the receiving device 200 side. Hereinafter, for convenience of simple and easy-to-understand explanation, the description that the electric field coupling is generated between the coupler 150 and the coupler 250 may be provided in consideration of the part in which the electric field is generated as the coupler itself in a broad sense.

Then, from the radiator 251, the signals in response to the electric field under the electric field coupling are loaded as reception signals to the communication processing unit 240. In the communication processing unit 240, the data is decoded by executing necessary demodulation processing of carrier component removal, depacketization, error correction processing from the input reception signals, and passed to the control unit 220. The control unit 220 writes the passed data in the memory 230 to be held therein.

### [Factors Deteriorating Communication Quality]

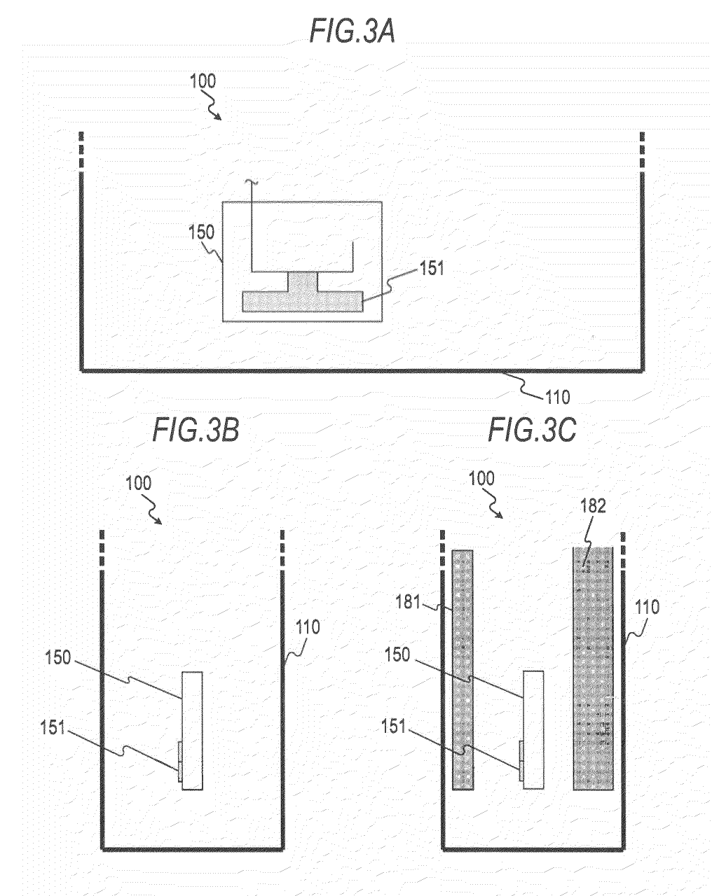

Next, in the near-field wireless communications using electric field coupling in the above described manner, factors deteriorating its communication quality will be explained with reference to FIGS. 3A to 3C. FIGS. 3A to 3C extract and show the outer casing 110 and the coupler 150 by taking the transmitting device 100 as an example. First, FIG. 3A is a front view of a state in which the coupler 150 is located within the outer casing 110 seen from the front. FIG. 3B is a side view corresponding to FIG. 3A.

Generally, many outer casings of electronic apparatuses are formed by resins. However, for example, because of performance, functions, design, or the like as products, at least parts of the outer casings may often be formed by metals.

Here, for example, it is assumed that at least a part in the outer casing 110 of the transmitting device 100 shown in FIGS. 3A and 3B is formed by a metal and the metal part is provided in a position that may affect the electric field generated in the coupler 150. Since the metal is a conductor, it acts to reflect or shield the radio wave that is about to pass through the outer casing 110 from the coupler 150, for example, and, as a result, weakens the electric field. If the electric field is weakened in this way, the loss of transmission signals becomes larger by that amount and the communication quality is deteriorated. The deterioration of the communication quality appears as reduction of the data transfer speed due to increase in error rate, transmission errors, or the like, for example.

Further, even when no metal is used for the outer casing 110, in some cases, metals should be accommodated within the outer casing 110 as parts or the like. As an example, in the side view of FIG. 3C, the state in which a metal frame 181 and a battery 182 are provided near the coupler 150 within the outer casing 110 is shown. The metal frame 181 is formed by a metal and provided in a proper position within the outer casing 110 for a predetermined purpose such as maintenance of the rigidity within, for example. Further, the battery 182 is a rechargeable battery, for example, and generally includes a metal. In this way, when the metal parts are provided within the outer casing 110, the communication quality is also deteriorated depending on their positions.

As described above, in the communication device of the embodiments of the invention performing communications by electric field coupling, there is the problem that the communication quality is deteriorated due to the existence of the outer casing or the metal parts within the outer casing. Although the transmitting device 100 is shown in FIGS. 3A to 3C, there is the same problem that the existence of those metal parts deteriorates the communication quality at the receiving device 200 side.

Such deterioration of communication quality may be avoided by providing no metal in a location that affects electric field coupling, for example. However, by providing no metal, the design of the outer casing may be limited, for example. Further, sufficient strength may not be maintained for the outer casing or inside the outer casing. Using no metal for the outer casing or inside the outer casing may not be an effective measure in practice.

### [Configuration Example of Electric Field Reinforcing Member]

Accordingly, in the embodiments of the invention, to obtain sufficient communication quality even in an apparatus using a metal in a position that may affect electric field coupling, a configuration including an electric field reinforcing member explained as below is proposed. In the following explanation, the configuration at the transmitting device 100 side is shown, however, the same configuration is applicable to the receiving device 200 side.

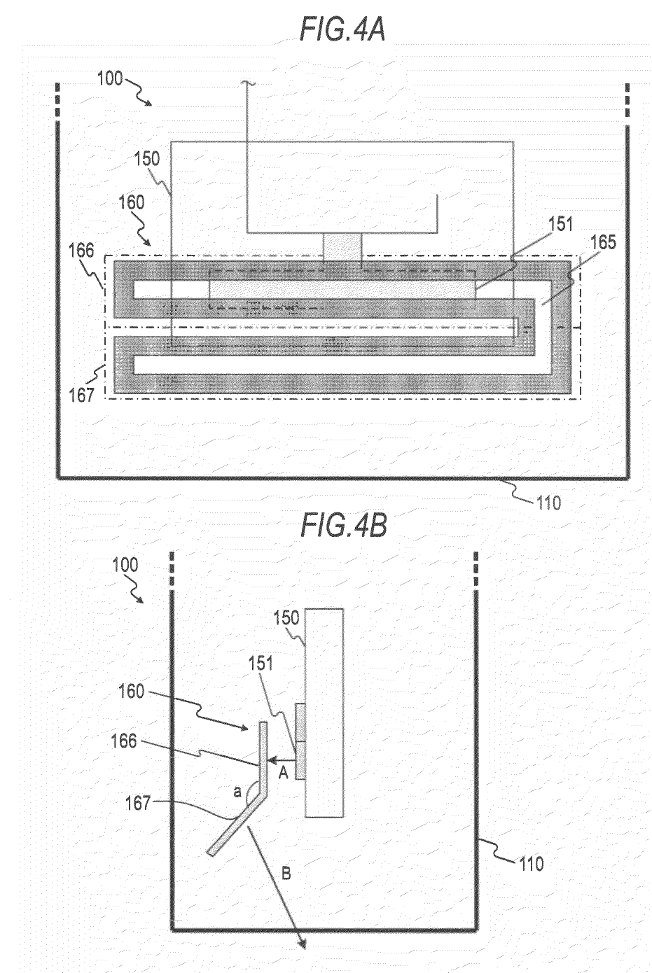

First, a front view of FIG. 4A and a side view of FIG. 4B show a configuration example as the first embodiment of the invention. In the drawings, like in FIGS. 3A and 3B, regarding the transmitting device 100, the outer casing 110 and the coupler 150 are extracted and shown. For convenience of easy-to-understand illustration of the configuration as the embodiment of the invention, the coupler 150 is enlarged to be larger relative to the size of the outer casing 110. In practice, the coupler 150 has a size to the degree that occupies only a part in the outer casing 110. The configuration of the coupler 150 itself has no difference from the configuration that has been explained with reference to FIGS. 1 and 2.

Further, as the first embodiment of the invention, as shown in FIGS. 4A and 4B, an electric field reinforcing member 160 is provided near the coupler 150 within the outer casing 110. Though not shown in the drawing, the electric field reinforcing member 160 is fixed within the outer casing 110.

As is known from that the electric field reinforcing member 160 has a planar shape in FIG. 4A and the member has only the width as a thickness in FIG. 4B, the electric field reinforcing member 160 has a shape that may be regarded as plate-like as a whole. The electric field reinforcing member 160 forms a shape shown in FIGS. 4A and 4B, for example, from a metal plate having a predetermined thickness.

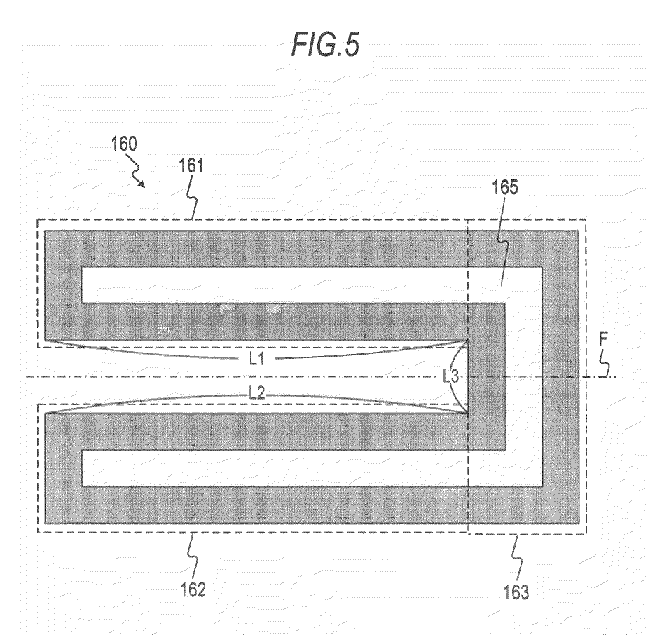

FIG. 5 extracts and shows the electric field reinforcing member 160 from FIG. 4A. The outer shape of the entire electric field reinforcing member 160 may be regarded as a shape obtained by providing a first leg part 161 and a second leg part 162 having rectangular shapes in the same size separately nearly in parallel along their longitudinal direction and joining the respective one ends (short sides) of the first leg part 161 and the second leg part 162 using a joining part 163. That is, it is formed as the so-called C-shape. Here, for convenience of explanation of the shape, the electric field reinforcing member 160 has been explained to include three parts of the first leg part 161, the second leg part 162, and the joining part 163, however, in practice, the C-shaped outer shape including these parts is integrally formed. For example, in practice, by cutting out the C-shaped outer shape shown in FIG. 5 from a metal plate, the outer shape of the electric field reinforcing member 160 with no slit 165, which will be described as below, formed therein may be obtained.

Further, in the electric field reinforcing member 160 shown in FIG. 5, in the C-shaped outer shape, the slit 165 is formed by cutting out the inside of the outer shape in the similar C-shape. The shape with the slit 165 formed may be regarded as a looped shape formed along the C-shape using a metal having a predetermined width in another view point. That is, the electric field reinforcing member 160 has a looped shape.

Of the sides forming the outer shape of the electric field reinforcing member 160 shown in FIG. 5, in the first leg part 161, the length of the side located in the position facing the second leg part 162 side is L1. Further, similarly, in the second leg part 162, the length of the side located in the position facing the first leg part 161 side is L2. Furthermore, the length of the side joining the two sides having the lengths of L1, L2 is L3. In addition, one wavelength corresponding to the electric field frequency for communications specified by the near-field wireless communications system with which the embodiments of the invention are compliant is λ. Assuming that the following equation (1) nearly holds, the lengths L1, L2, and L3 are set.

L1+L2+L3=λ/2 (1)

Regarding the size setting of the electric field reinforcing member 160, the equation (1) does not necessarily hold in a strict sense, for example, as a measure, the sum of the lengths L1, L2, and L3 may fall within the range of length that may be regarded as λ/2.

As described above, in the first embodiment of the invention, of the sides of the outer shape of the electric field reinforcing member 160, the length of the three sides joined inside is set to about a half of the wavelength. Since the electric field frequency of the near-field wireless communications system with which the embodiments of the invention are compliant is 4.48 GHz, one wavelength is about 6.7 cm. Therefore, in practice, the electric field reinforcing member 160 is formed so that L1+L2+L3 may be about 3.35 cm. Thereby, the length of the loop formed in the electric field reinforcing member 160 may be regarded as nearly one wavelength.

Further, the electric field reinforcing member 160 is bent in a bending position nearly at the center of the joining part 163 shown as a dashed-dotted line F in FIG. 5 so that the shape seen from its side surface may be a dogleg shape as shown in FIG. 4B. That is, a predetermined angle a smaller than 180 degrees may be provided.

The electric field reinforcing member 160 bent into the dogleg shape in the above described manner is divided into two flat parts with the bending position shown by the dashed-dotted line F in FIG. 5 as a boundary. As shown in FIG. 4A, these flat parts are an electric field receiving surface part 166 and a radiation surface part 167, respectively. Further, as shown in FIG. 4B, the electric field receiving surface part 166 is provided to face the surface of the radiator 151 of the coupler 150 nearly in parallel. The radiation surface part 167 is located lower than the radiator 151 in the drawing. This means that the radiation surface part 167 is located nearer the coupler 250 (radiator 251) at the receiving device 200 side (not shown). Furthermore, by providing the angle a between the electric field receiving surface part 166 and the radiation surface part 167, the radiation surface part 167 is directed nearly toward the coupler 250 of the receiving device 200 (not shown). This corresponds to the setting of the radiation direction of the electric field to be reradiated, which will be described below.

The electric field reinforcing member 160 employing the above described shape and arrangement form functions in the following manner when electric field coupling is generated between the radiator 151 at the transmitting device 100 side and the radiator 251 at the receiving device 200 side. That is, first, in the electric field reinforcing member 160, the electric field generated from the radiator 151 is received by the electric field receiving surface part 166. Then, the received electric field is reradiated by the radiation surface part 167. As a result, to the radiator 251 at the receiving device 200 side, the component directly radiated from the radiator 151 and the component reradiated from the electric field reinforcing member 160 are synthesized and radiated. Therefore, by providing the electric field reinforcing member 160, the more reinforced electric field is provided.

Thereby, for example, even when a metal exists around the coupler and the electric field is weakened due to the action of its reflection and shielding, the weakened amount may be reinforced by the electric field reinforcing member 160. That is, even when a communication device has a structure in which a metal exists around the coupler, communication quality enough for practical use may be maintained.

### [Another Example of Positional Relationship of Electric Field Reinforcing Member and Coupler]

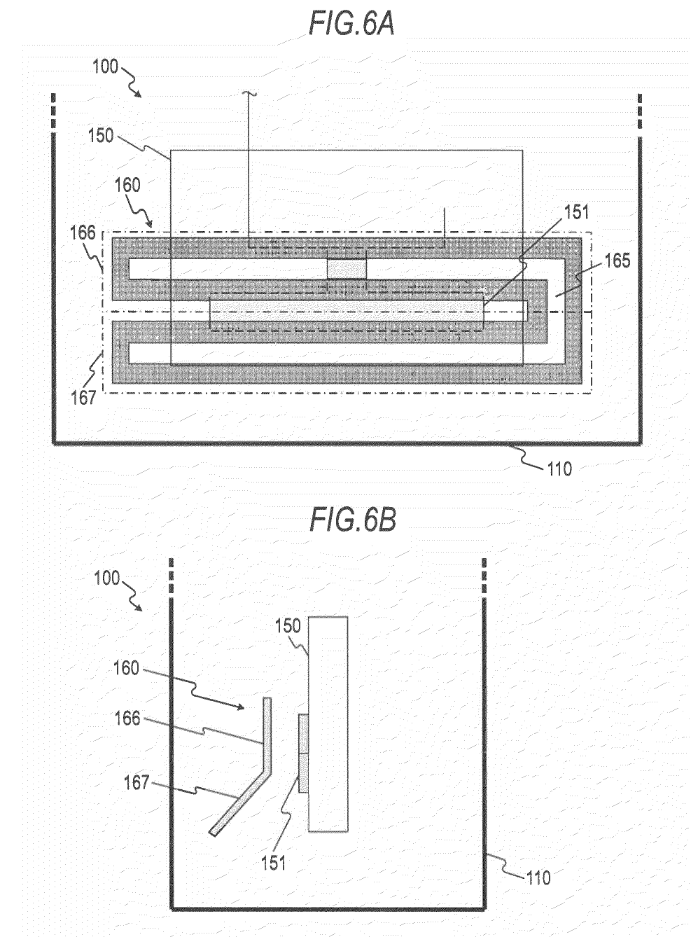

FIGS. 6A and 6B show another example of a positional relationship of the electric field reinforcing member 160 and the coupler 150 (radiator 151). FIG. 6A is a front view and FIG. 6B is a side view.

The position of the electric field reinforcing member 160 in FIGS. 6A and 6B is changed to the upper side relative to the coupler 150 compared to the case of FIGS. 4A and 4B. Specifically, in FIG. 4A, for example, in the electric field reinforcing member 160, the part of the slit 165 at the electric field receiving surface part 166 side nearly faces the radiator 151. On the other hand, FIG. 6A shows that the space part between the electric field receiving surface part 166 and the radiation surface part 167 in the electric field reinforcing member 160 nearly faces the radiator 151.

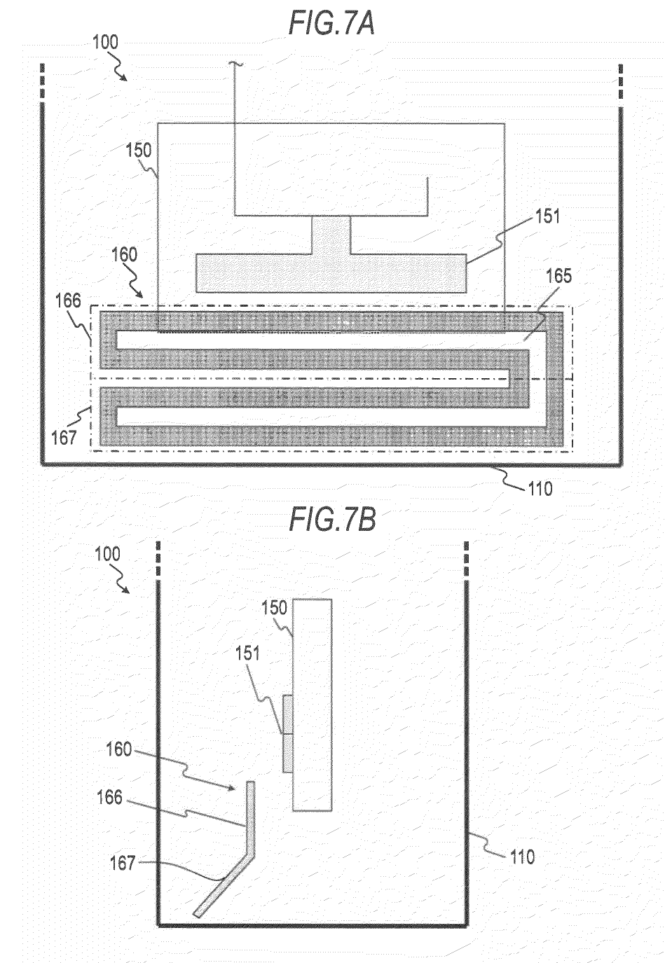

Further, FIGS. 7A and 7B show yet another example of the positional relationship of the electric field reinforcing member 160 and the coupler 150 (radiator 151) in the first embodiment of the invention. FIG. 7A is a front view and FIG. 7B is a side view. In FIGS. 7A and 7B, the position of the electric field reinforcing member 160 itself is set lower than the radiator 151.

In the first embodiment of the invention, the position of the electric field reinforcing member 160 may be changed as exemplified in FIGS. 4A and 4B, 6A and 6B, and 7A and 7B, any position has the following relationship in common. That is, the positional relationship is that the electric field receiving surface part 166 is near the coupler 150 (radiator 151) within the same transmitting device 100 side, and the radiation surface part 167 is near the coupler 250 (radiator 251) at the receiving device 200 side (not shown). Thereby, the operation of receiving the electric field from the radiator 151 and reradiating it by the electric field reinforcing member 160 may be obtained not only in the case of FIGS. 4A and 4B but also in the case of FIGS. 6A and 6B or 7A and 7B. Note that the coupler 250 (radiator 251) at the receiving device 200 side is an example of a communication destination coupler described in the appended claims.

[Example of Fixed State of Electric Field Reinforcing Member within Outer Casing]

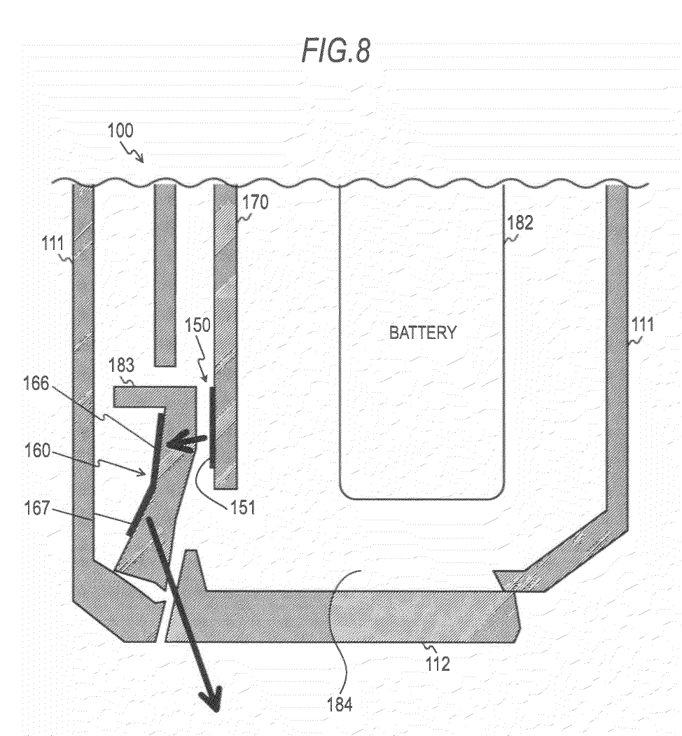

Next, FIG. 8 shows a specific example of a fixed state of the electric field reinforcing member 160 within the outer casing. FIG. 8 is a sectional view showing a specific shape of the outer casing and an interior thereof. In the drawing, the outer casing includes parts of an outer casing main body 111 and a battery lid part 112. The outer casing main body 111 is a part of a main body part formed by the outer casing of the transmitting device 100, for example. Further, the battery lid part 112 is openably and closably supported by an opening and closing mechanism (not shown). Thereby, for example, by opening an opening part 184 by the battery lid part 112, a battery 182 may be attached to and detached from inside of the main body. In the drawing, the state in which the opening part is closed by the battery lid part 112 is shown. For example, when a user of the transmitting device 100 replaces the battery 182, the battery lid part 112 is opened and the battery 182 is drawn out from the opening part. Further, the drawn out battery 182 is inserted from the opening part and loaded.

In FIG. 8, on the left of the battery 182 loaded within the outer casing 110 in the above described manner, a substrate 170 is provided. On the substrate 170, the coupler 150 is formed. The substrate 170 is fixedly provided inside of the outer casing 110. Therefore, the coupler 150 formed on the substrate 170 is fixedly provided within the transmitting device 100. In addition, an in-casing resin part 183 is provided near the left side on which the coupler 150 is formed. The in-casing resin part 183 is a part formed by a resin for a predetermined purpose within the outer casing.

Accordingly, in this example, as shown in the drawing, in the in-casing resin part 183, the electric field reinforcing member 160 is provided by bonding it to the position where the optimal positional relationship to the radiator 151 is obtained. If the positional relationship between the electric field reinforcing member 160 attached to the in-casing resin part 183 and the coupler 150 is extracted, it is known that the relationship is nearly the same as that in FIG. 4A, for example.

Here, since the in-casing resin part 183 to which the electric field reinforcing member 160 is attached in the above described manner is the resin, it has correspondingly high permittivity as a dielectric material. By the dielectric operation of the in-casing resin part 183, a wavelength of the electric field effective in the electric field reinforcing member 160 is made shorter than that in practice. For example, by the inventors of the present invention, it is known that the wavelength is made shorter to 10 to 20%. Accordingly, the electric field reinforcing member 160 shown in FIG. 8 may be formed by setting the length of L1+L2+L3 explained with reference to FIG. 5 to about 80 to 90% of λ/2. Thereby, the electric field reinforcing member 160 may be made in the smaller size.

### [Configuration Example of Removable Communication Function]

Further, as above, the configuration in which the communication function has been incorporated is explained as the transmitting device 100, for example. However, for example, it is conceivable that the configuration in which the transmitting device 100 itself originally has no communication function and the communication function as the transmitting device 100 may be obtained by loading a removable-type device having the communication function is employed.

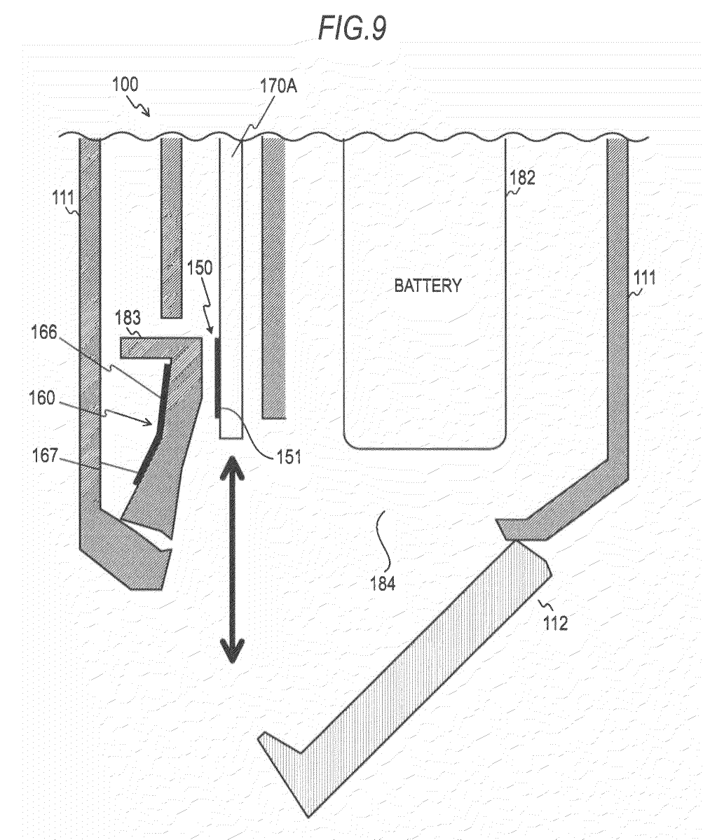

A specific example of the configuration is shown in FIG. 9. As shown in the drawing, as the transmitting device 100, in place of the substrate 170 shown in FIG. 8, a card-type communication device 170A is attached. The card-type communication device 170A is of removal-type and has at least a configuration of the communication processing unit 140 and the coupler 150 in correspondence to the configuration in FIG. 1, for example. Therefore, when the card-type communication device 170A is not loaded, the transmitting device 100 does not include the communication processing unit 140 or the coupler 150, that is, has no communication function.

In order to provide the communication function to the transmitting device 100, the user loads the card-type communication device 170A by opening the battery lid part 112 and inserting it into a predetermined insertion opening from the opening part 184. In the transmitting device 100, the part in and from which the card-type communication device 170A is attached and detached is an example of a communication device attaching and detaching part described in the appended claims. Further, when the communication device attaching and detaching unit card-type communication device 170A is properly loaded and the battery lid part 112 is closed, the control unit 120 at the transmitting device 100 side and the communication processing unit 140 of the card-type communication device 170A are electrically connected, and the transmitting device 100 can control the communication by controlling the communication processing unit 140 and the coupler 150. That is, the communication function of the embodiment of the invention is provided. Further, when the card-type communication device 170A is properly loaded, the coupler 150 is located in a specified position within the outer casing of the transmitting device 100 as shown in the drawing. In this case, the electric field reinforcing member 160 should be bonded to the in-casing resin part 183 so that the optimal positional relationship to the coupler 150 located in the specified position may be obtained.

As described above, the electric field reinforcing member 160 may be provided in another device than the device actually having the coupler 150. For example, in the case where the card-type communication device 170A is of removal type as shown in FIG. 9, the card-type communication device 170A loaded in the transmitting device 100 is not particular one, but may be different on various occasions. Accordingly, by providing the electric field reinforcing member 160 at the transmitting device 100 side, the electric field may be reinforced for any of the loaded card-type communication devices 170A in common. In this case, it becomes unnecessary to provide a configuration for electric field reinforcement to the card-type communication device 170A side.

[Case where Electric Field Reinforcing Members are Provided in Both Transmitting Device and Receiving Device]

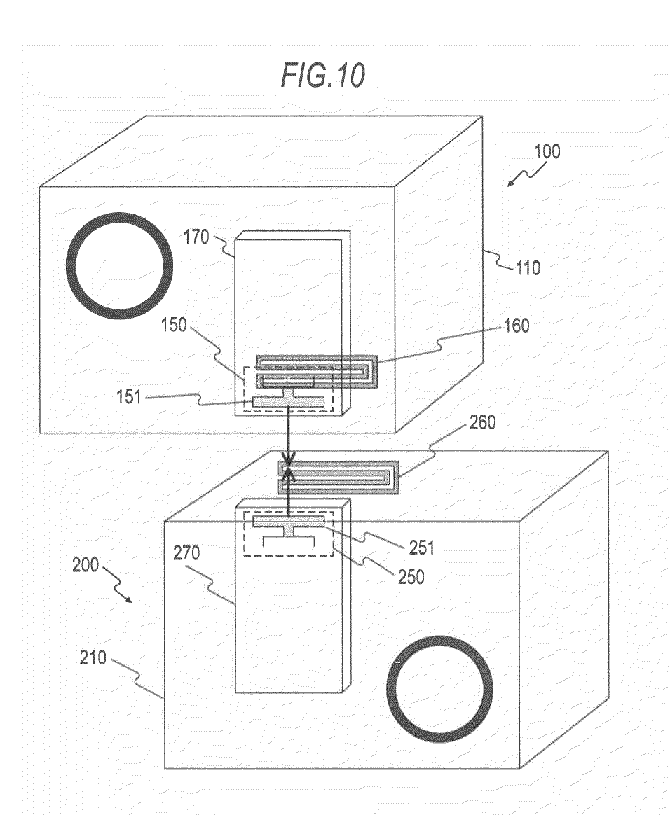

In the above description, the configuration in which the electric field reinforcing member 160 is provided has been explained by taking the transmitting device 100 as an example. However, the configuration in which the electric field reinforcing member is provided may be provided also in the receiving device side as the other side of the communications. A perspective view of FIG. 10 schematically shows an arrangement form within the outer casing when the electric field reinforcing member 160 or 260 is provided in the transmitting device 100 and receiving device 200, respectively.

At the transmitting device 100 side, in the outer casing 110, the coupler 150 is formed on the substrate 170 according to the structure shown in FIG. 8, for example. Further, in response to the position of the radiator 151 of the coupler 150, the electric field reinforcing member 160 is provided. Furthermore, also, in the receiving device 200, the coupler 250 is provided on a substrate 270 and an electric field reinforcing member 260 is provided in response to the position of the radiator 251 within the outer casing 210.

In the case where the receiving device 200 is a device of the same type as the transmitting device 100, the receiving device 200 has the same outer shape as that of the transmitting device 100, and additionally, the coupler 250 and the electric field reinforcing member 260 are provided in the same arrangement positions and forms within the outer casing 210. Note that the coupler 250 and the electric field reinforcing member 260 in the receiving device 200 in this case may be the same as the coupler 150 and the electric field reinforcing member 160 at the transmitting device 100 side. Further, when communications is allowed to be made at the transmitting device 100 side and the receiving device 200 side, as shown in the drawing, for example, the couplers 150 and 250 within the devices may be within the communicable distance range. In this regard, for example, the transmitting device 100 and the receiving device 200 may be made close to each other, or in contact with each other. Thereby, electric field coupling is generated between the coupler 150 and the coupler 250 and communications is made.

In the case where the electric field reinforcing member 260 is provided at the receiving device 200 side as described above, the electric field reinforcing member 260 at the receiving device 200 side functions in the following manner, for example. That is, the electric field reinforcing member 260 receives the electric field radiated from the coupler 150 of the transmitting device 100 and propagating to the receiving device 200 by the surface nearer the transmitting device 100 (coupler 150) side. Further, the received electric field is radiated from the surface facing the radiator 251 of the electric field reinforcing member 260 to the radiator 251. Thus, in the receiving device 200, for example, in the case where the electric field reinforcing member 260 is provided in the same manner as that of the transmitting device 100 as shown in FIGS. 4A and 4B, for example, the electric field receiving surface part 166 and the radiation surface part 167 are exchanged. In addition, as understood from the above explanation, also, by providing the electric field reinforcing member 260 at the receiving device 200 side, the electric field received by the radiator 251 can be reinforced at the reception side. Therefore, by using the configuration in which the electric field reinforcing member is provided of the embodiment of the invention both at the transmitting device side and the receiving device side, the effect of the electric field reinforcement may further be improved.

### 2. Modified Examples

### First Modified Example

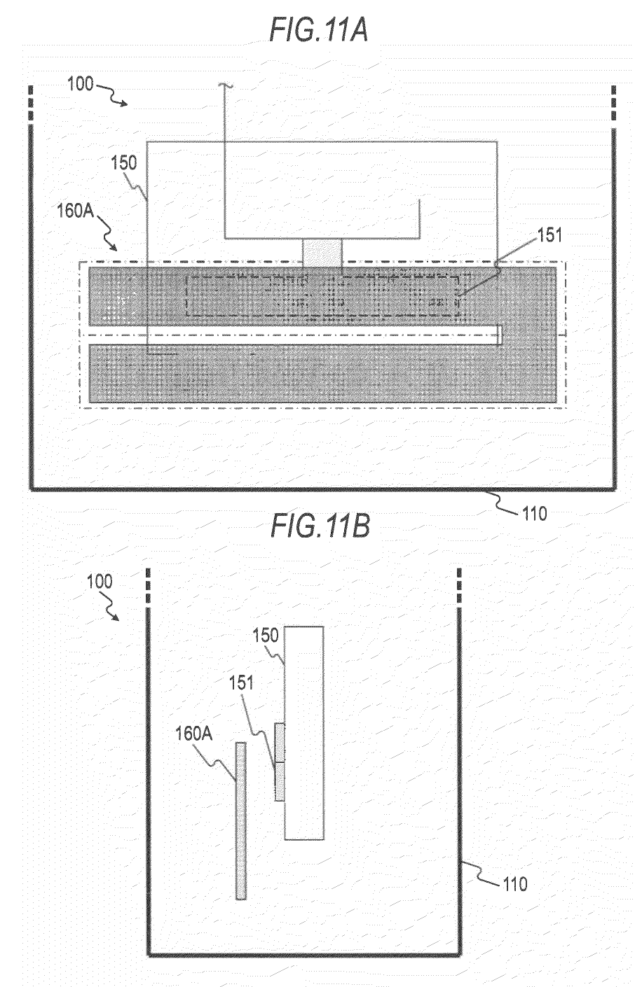

FIGS. 11A and 11B show a configuration example of the electric field reinforcing member 160 as a first modified example in the embodiment of the invention. In the drawings, the same signs are assigned to the same parts as those in FIGS. 4A and 4B and their explanation will be omitted. In an electric field reinforcing member 160A in this case, the slit 165 formed in the electric field reinforcing member 160 as shown in FIGS. 4A and 4B, for example is omitted and the member is formed as a C-shaped flat plate as known from the front view of FIG. 11A. That is, the electric field reinforcing member 160A in this case is formed not in the looped shape but as a flat plate having a C-shaped outer shape.

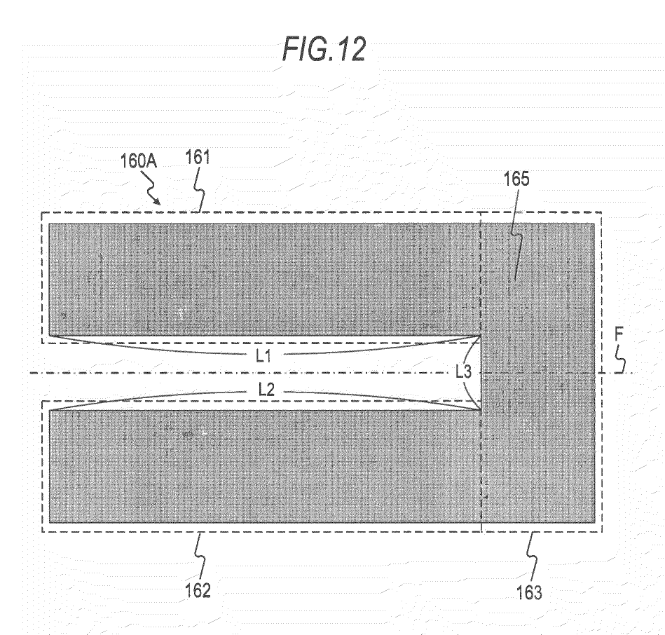

Note that, the size of the electric field reinforcing member 160A may be specified in the same manner as that of the electric field reinforcing member 160 of the first embodiment of the invention. That is, as shown in FIG. 12, the size should be set so that the above described equation (1) may be satisfied with respect to the length L1 of the inner side of the first leg part 161, the length L2 of the inner side of the second leg part 162, and the length L3 of the side joining the sides. Thereby, the performance of the electric field reinforcement of the electric field reinforcing member 160A can be made the highest. In addition, in the case where the electric field reinforcing member 160A is provided in contact or close to a dielectric material such as a resin as exemplified in FIG. 8, for example, the lengths L1, L2, and L3 of the respective sides may be set according to the shortening rate of the wavelength λ in response to the permittivity of the dielectric material. The dielectric material here may be not only the resin cited above as the in-casing resin part 183 but also ceramics or glass, for example.

As shown in the side view of FIG. 11B, the electric field reinforcing member 160A in this case is not bent like the electric field reinforcing member 160 in FIGS. 4A and 4B but has a flat surface. Even the flat shape can fulfill the function of receiving and reradiating the electric field from the coupler 150 by the setting of the positional relationship between the electric field reinforcing member 160 and the coupler 150 side, for example. Further, FIGS. 11A and 11B show an example of the positional relationship between the electric field reinforcing member 160A and the coupler 150 set nearly in the same as that in FIGS. 4A and 4B. However, even when the electric field reinforcing member 160A is employed, the positional relationship exemplified in FIGS. 6A and 6B and 7A and 7B may be set.

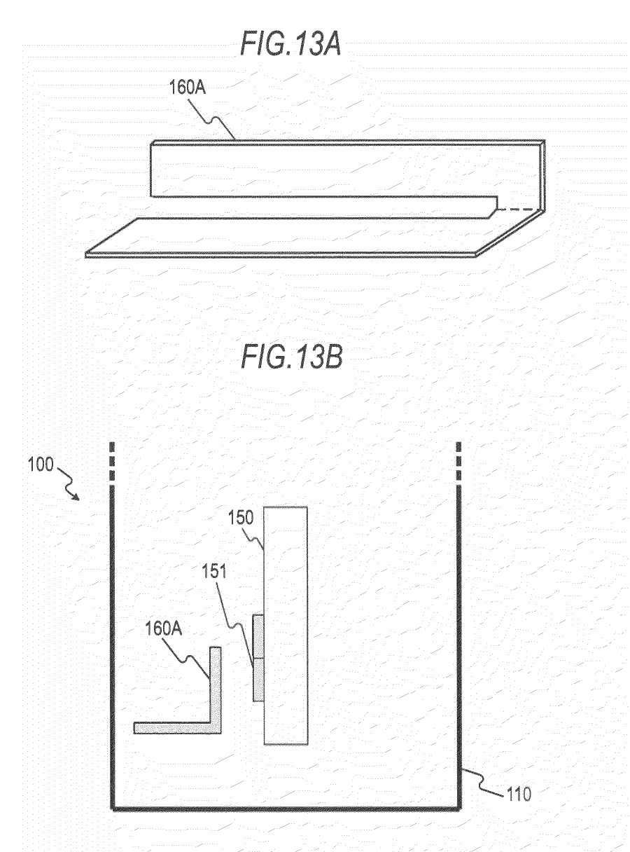

Furthermore, the electric field reinforcing member 160A may be in a shape formed by bending it so that the respective flat surfaces of the first leg part 161 and the second leg part 162 may form an angle of substantially 90 degrees along a dashed-dotted line F in FIG. 12 as shown in a perspective view of FIG. 13A. In this case, as shown in a side view of FIG. 13B, for example, the electric field reinforcing member 160A is provided so that the surface orthogonal to the communication direction may be directed toward the side opposite to the radiator 151, for example.

The form in which the electric field reinforcing member is bend at substantially 90 degrees and provided may be applied to the electric field reinforcing member 160 having the slit 165 shown as above as the first embodiment of the invention, for example.

### Second Modified Example

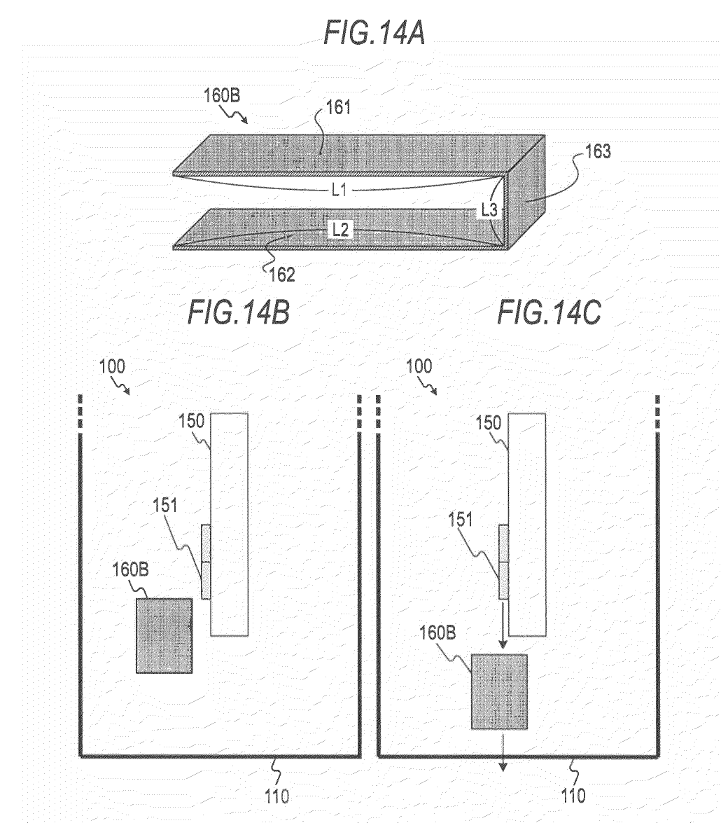

FIGS. 14A to 14C show a configuration example of an electric field reinforcing member 160B as a second modified example in the embodiment of the invention. In the electric field reinforcing members 160 and 160A that have been shown in FIGS. 4A and 4B and 11A and 11B, the C-shapes are formed as the flat surface shapes of the plates. On the other hand, in the electric field reinforcing member 160B of the second modified example, a C-shape is formed by bending a rectangular plate as known from the perspective view of FIG. 14A. That is, the entire shape formed by its thickness part is C-shaped.

Also, in this case, setting the size so that the lengths L1, L2, L3 of the inner three sides forming the C-shape may satisfy the equation (1) is the same as in the cases of the first embodiment and the first modified example of the invention. Further, setting the lengths L1, L2, L3 in response to the wavelength shortened according to the shortening rate in the case where the electric field reinforcing member 160B is provided in contact or close to a dielectric material is also the same as in the case of the first embodiment and the first modified example of the invention. Note that, in the case of the electric field reinforcing member 160B, the width of the leg part seen from the side at which the C-shape is formed corresponds to the thickness of a metal plate forming the electric field reinforcing member 160B. Therefore, in the electric field reinforcing member 160B, for example, the respective lengths L1, L2, and L3 may be regarded as the lengths of the first leg part 161, the second leg part 162, and the joining part 163. That is, the electric field reinforcing member 160B as the second modified example may be formed by bending the rectangular metal plate having the length of L1+L2+L3 that may correspond to λ/2.

Further, in the second modified example, as positional relationships between the electric field reinforcing member 160B and the coupler 150 (radiator 151) in the outer casing 110, two examples of FIGS. 14B and 14C are cited. First, in FIG. 14B, the example in which the electric field reinforcing member 160B is located before the lower side of the radiator 151 in the outer casing 110 is shown. That is, the arrangement is that the surface of the upper leg part in the electric field reinforcing member 160B is made close to the radiator 151, and the surface of the lower leg part is located near the coupler 250 at the receiving device 200 (not shown).

In the next FIG. 14C, the electric field reinforcing member 160B is located nearly beneath the radiator 151 in the outer casing 110. In this state, the electric field reinforcing member 160B is located between the radiator 151 and the coupler 250 (radiator 251) at the receiving device 200 side (not shown). For example, according to confirmation by the inventors, in comparison between the configurations of FIGS. 14B and 14C, the higher communication quality is obtained in the configuration of FIG. 14C.

### Third Modified Example

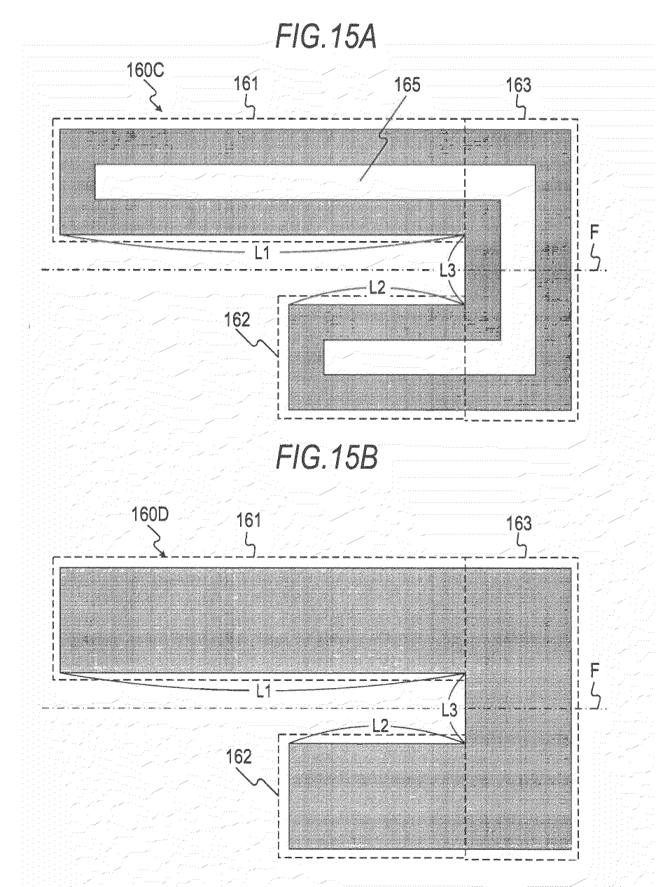

A third modified example of the embodiment of the invention will be explained with reference to FIGS. 15A and 15B. An electric field reinforcing member 160C shown in FIG. 15A is application of the third modified example based on the electric field reinforcing member 160 shown in FIG. 4A. Further, an electric field reinforcing member 160D of FIG. 15B is application of the third modified example based on the electric field reinforcing member 160A as the first modified example shown in FIGS. 11A and 11B.

In the above described first embodiment and the first and second modified examples, the same lengths have been set regarding two of the first leg part 161 and the second leg part 162 forming the C-shape as the electric field reinforcing member. On the other hand, in the third modified example, for example, as shown in FIGS. 15A and 15B, the first leg part 161 and the second leg part 162 are set in different lengths from each other.

Also, in this case, L1+L2+L3 as the sum of the respective lengths of the two sides at the side at which the first leg part 161 and the second leg part 162 are opposed and one side joining the two sides should be set in response to a half of the wavelength. Further, the electric field reinforcing members 160, 160A shown in FIGS. 15A and 15B may be formed in shapes bent at less than 90 degrees or substantially 90 degrees along the dashed-dotted line F, for example, as shown in FIGS. 4A and 4B and 13A and 13B.

Furthermore, in the third modified example, an arrangement in which the longer leg part side is located nearer the radiator 151 and the shorter leg part side is located nearer the coupler 250 of the receiving device 200 and an arrangement opposite thereto are conceivable. In the case of the opposite arrangement, the shorter leg part side is located nearer the radiator 151 and the longer leg part side is located nearer the coupler 250 of the receiving device 200. In this regard, the arrangement may be selected in view of various conditions actually envisioned. For example, in the case where prime importance is placed on the communication quality, tests may actually be performed and the arrangement by which better communication quality can be obtained may be selected. Or, it is conceivable that the more appropriate one may be selected according to the shape of the actual attachment part of the electric field reinforcing member within the outer casing 110.

Note that the electric field reinforcing members in the embodiment and the modified examples may be formed using metal-worked plates, or may be formed using tape-like copper, aluminum, or the like, for example.

Further, for the loop formed as in the electric field reinforcing member 160 of the first embodiment of the invention, for example, a structure in which a loop is formed by a linear metal is conceivable.

Furthermore, in the above explanation, the electric field reinforcing member has the shape including linear sides forming the substantially C-shape. However, an outer shape forming a U-shape as a whole such that the joining part forms a curved side, for example, is conceivable.

In addition, the embodiments of the invention show examples for implementing the invention, and, as clearly shown in the embodiments of the invention, the items in the embodiments of the invention and the items specifying the invention in the appended claims respectively have correspondence relations. Similarly, the items specifying the invention in the appended claims and the items in the embodiments of the invention referred to as the same respectively have correspondence relations. Note that the invention is not limited to the embodiments and may be realized by making various changes to the embodiments without departing from the scope of the invention.

The present application contains subject matter related to that disclosed in Japanese Priority Patent Application JP 2009-297767 filed in the Japan Patent Office on Dec. 28, 2009, the entire contents of which is hereby incorporated by reference.

What is claimed is:

1. An electronic apparatus comprising:
an electric field reinforcing member as a plate-like metal provided in a predetermined position within an outer casing set in response to a specified position of a coupler for generating electric field coupling between a communication destination coupler located within a predetermined communicable distance and itself within the outer casing, having an outer shape in which two leg parts having a positional relationship spaced from each other and a joining part joining the respective one ends of the leg parts are integrally formed, and having lengths of side parts forming an interior of the outer shape set based on a half of a wavelength in response to an electric field frequency generated by the electric field coupling.

2. The electronic apparatus according to claim 1, wherein the electric field reinforcing member is provided in contact with or close to a dielectric material within the outer casing, and the lengths of the side parts forming the interior of the outer casing are set based on the half of the wavelength shortened according to permittivity of the dielectric material.

3. The electronic apparatus according to claim 1, wherein the electric field reinforcing member has the outer shape in a direction of the plate-like flat surface, and a surface part formed by one leg part and a surface part formed by the other leg part form a predetermined angle using a direction along the two leg parts in a part corresponding to the joining part as a bending position.

4. The electronic apparatus according to claim 3, wherein the surface part formed by one leg part in the electric field reinforcing member is located near the specified position of the coupler within the outer casing and the surface part formed by the other leg part in the electric field reinforcing member is located nearer the communication destination coupler than the specified position of the coupler within the outer casing.

5. The electronic apparatus according to claim 3, wherein the electric field reinforcing member is formed in a looped shape along the outer shape.

6. The electronic apparatus according to claim 1, wherein the electric field reinforcing member is formed so that a thickness part of the plate-like metal may have the outer shape.

7. The electronic apparatus according to claim 6, wherein the electric field reinforcing member is provided in a position between the specified position of the coupler within the outer casing and the communication destination coupler.

8. The electronic apparatus according to claim 1, wherein the electric field reinforcing member has the two leg parts having different lengths from each other.

9. The electronic apparatus according to claim 1, further comprising:
a communication device attaching and detaching part as a part in and from which a communication device including the coupler is attached and detached formed so that, if the communication device is properly loaded, the coupler may be located in the specified position within the outer casing.

10. A communication device for generating electric field coupling between a communication destination coupler located within a predetermined communicable distance and itself, comprising:
a coupler provided in a predetermined position within an outer casing; and
an electric field reinforcing member as a plate-like metal having an outer shape in which two leg parts having a positional relationship spaced from each other and a joining part joining the respective one ends of the leg parts are integrally formed, and having lengths of side parts forming an interior of the outer shape set based on a half of a wavelength in response to an electric field frequency generated by the electric field coupling.
